(19) United States
(12) Patent Application Publication
(10) Pub. No.: US 2018/0178327 A1
(43) Pub. Date: Jun. 28, 2018

(54) METHOD OF REMANUFACTURING A CYLINDER HEAD

(71) Applicant: Caterpillar Shrewsbury Limited, Shrewsbury (GB)

(72) Inventors: Christopher Smith, Trewern (GB); Chunlei Qiu, Cardiff (GB); Moataz M.M. Attallah, Edgbaston (GB); Stefan Simeonov Dimov, Edgbaston (GB)

(73) Assignee: Caterpillar Shrewsbury Limited, Shrewsbury (GB)

(21) Appl. No.: 15/843,808

(22) Filed: Dec. 15, 2017

(30) Foreign Application Priority Data
Dec. 23, 2016 (GB) 1622160.8

(51) Int. Cl. B23K 26/342; B23P 6/02; B23P 6/04; B23K 26/082; B23K 26/06

(52) U.S. Cl. CPC B23K 26/342; B23P 6/02; B23K 26/0626; B23K 26/082; B23P 6/04

(57) ABSTRACT

A method of remanufacturing a cylinder head comprises the steps of removing material from the cylinder head around at least a portion of a crack in the cylinder head to form a slot, and applying a compound material using direct laser deposition to fill the slot. The direct laser deposition includes performing a pre-scanning operation at a first laser power and a first scan speed, and depositing the compound material at a second laser power and a second scan speed. The second laser power and the second scan speed may be respectively equal to or different from the first laser power and first scan speed. The first laser power and the second laser power are less than or equal to 700 W. The first scan speed and second scan speed are less than or equal to 700 mm/minute.

### TECHNICAL FIELD

This disclosure is directed to a method of remanufacturing a cylinder head, and in particular to a method of remanufacturing a cylinder head by repairing a crack.

### BACKGROUND

Many components of an internal combustion engines are subjected to high loads and wear during operation of the engine. For example, a cylinder head is subjected to cyclical thermal stresses due to a rapidly and repeatedly changing working temperature during the combustion cycle. In addition, the tensile strength and stiffness of its material (typically cast iron) is relatively low. As a result, it is common for cracks to propagate in the region of the valve seats of the air inlet and exhaust ports on the cylinder head, where stresses are highest.

Engines typically have a predetermined service lifespan, after which they may be decommissioned. For example, a diesel engine for a diesel multiple unit (DMU) train may have a lifespan of 400000 miles. Decommissioned engines may be remanufactured so that they may be put back into service, which may represent a significant monetary and environmental cost saving relative to manufacturing a new engine. To remanufacture an engine, the engine may be stripped down and the constituent parts checked for cracks, for example by using magnetic particle inspection. Any faulty or degraded parts, such as the cylinder head, are replaced in the remanufactured engine. The faulty or degraded parts are typically then discarded, unless they themselves can be remanufactured.

Additive manufacturing techniques, such as direct laser deposition (DLD) (also known as laser metal deposition, direct metal deposition, laser engineered net shaping, laser cladding, laser deposition welding, or powder fusion welding) may be advantageous for repairing and remanufacturing components and structures. Relative to conventional repairing techniques such as electrical arc welding, the heat input of DLD is controllable and may be minimised to avoid development of significant residual stress present in the repaired regions, which is good for structural integrity of the remanufactured components.

### SUMMARY

The present disclosure provides a method of remanufacturing a cylinder head, the method comprising the steps of: removing material from the cylinder head around at least a portion of a crack in the cylinder head to form a slot; and applying a compound material using direct laser deposition to fill the slot; wherein the direct laser deposition includes: performing a pre-scanning operation at a first laser power and a first scan speed; and depositing the compound material at a second laser power and a second scan speed, wherein the second laser power and the second scan speed may be respectively equal to or different from the first laser power and first scan speed; and wherein the first laser power and the second laser power are less than or equal to 700 W; and the first scan speed and second scan speed are less than or equal to 700 mm/minute.

For the purpose of this disclosure, the term ‘remanufacturing’ includes both remanufacturing and repairing.

By way of example only, embodiments of a method of remanufacturing a cylinder head are now described with reference to, and as shown in, the accompanying drawings.

### BRIEF DESCRIPTION OF THE DRAWINGS

FIG. 1 is a plan view of a cylinder head;

FIG. 2 is a magnified perspective view of an inlet port and injector port from the cylinder head of FIG. 1, showing a crack;

FIG. 3 is a schematic view of a typical DLD system;

FIG. 4 is the magnified perspective view of an inlet port and injector port of FIG. 2, with a slot machined in the region of the crack;

FIGS. 5 to 8 are schematic views of a suitable toolpath strategy for the DLD;

FIGS. 9 to 12 are schematic views of a simplified toolpath strategy for the DLD; and

FIGS. 13 to 18 are cross-sections of various samples built using DLD in parametric studies.

### DETAILED DESCRIPTION

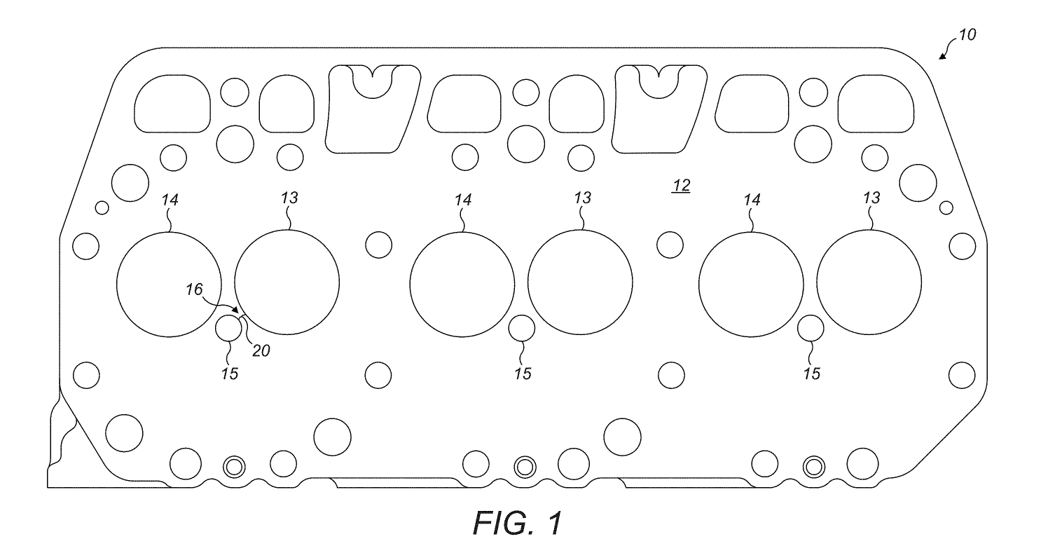

FIG. 1 illustrates an example cylinder head 10 for an internal combustion engine, (not illustrated), such as a diesel engine. The cylinder head 10 of FIG. 1 may be attached to a cylinder block housing three cylinders of an in-line six cylinder engine. However, the method described herein may be used for cylinder heads configured to be used with other configurations of cylinder blocks having different numbers of cylinders. The cylinder head 10 may have a first face (not shown) and an opposing second face 12. The first face of the cylinder head 10 may be configured to sit on a surface of the cylinder block such that each cylinder, which houses a reciprocating piston, is closed at one end by the first face of the cylinder head 10 to form a combustion chamber (not shown). The first face of the cylinder head 10 may be provided with features (not shown) for aligning with each of the cylinders.

The second face 12 of the cylinder head 10 may be provided with a plurality of inlet ports 13, exhaust ports 14, and injector ports 15. The injector ports 15 may be threaded. In the cylinder head 10 of FIG. 1, one inlet port 13, one exhaust port 14, and one injector port 15 may be provided per cylinder. However, other arrangements are common in the art, such as dual-intake arrangements having two inlet ports and two exhaust ports per cylinder. The cylinder head 10 may typically be manufactured from cast iron, and may be a one-piece casting.

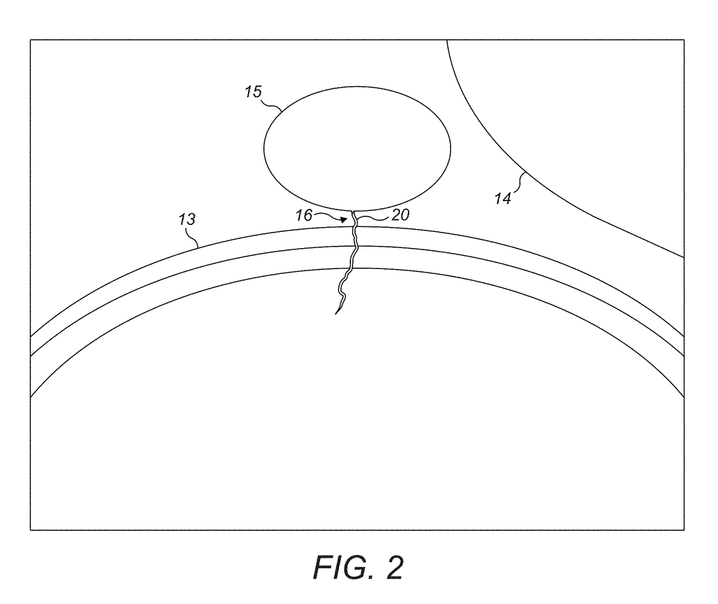

During the lifespan of an internal combustion engine, one or more cracks 20 may form in the cylinder head 10. For example, a crack 20 may form in the region of the inlet and exhaust ports 13,14 on the second face 12 of the cylinder head 10, where stresses may be very high. As shown in FIGS. 1 and 2, a crack 20 may typically form at the narrowest bridge in the region of the inlet port 13 and exhaust port 14, which may be the bridge 16 between the inlet port 13 and the injector port 15.

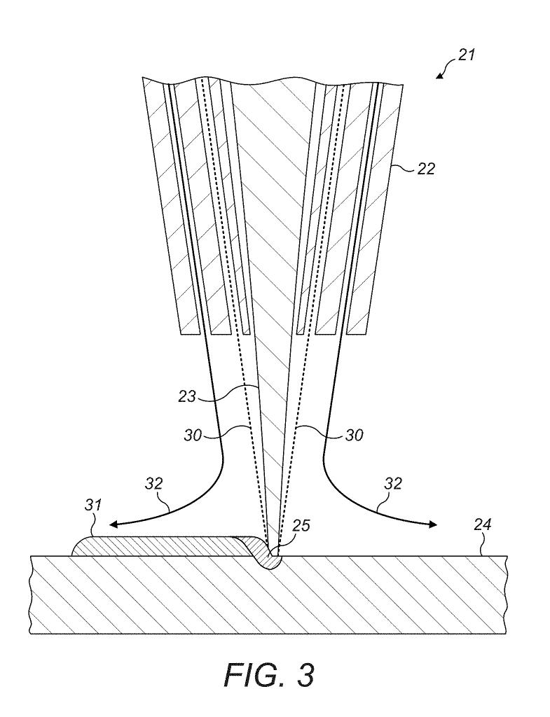

The faulty cylinder head 10 may be remanufactured by repairing the crack 20 using DLD. FIG. 3 shows a typical DLD system 21, wherein a deposition head 22 may direct a laser beam 23 onto a substrate 24 to form a melt pool 25. The substrate 24 may be any workpiece onto which DLD is to be performed. In the case of the present disclosure, the substrate 24 may be the cylinder head 10. A spot size of the laser beam 23 may be defined by a focus number, where a larger focus number may produce a wider laser beam and therefore a wider melt pool 25. The deposition head 22 may feed a compound material 30, typically a powdered metal alloy, into the melt pool 25, where the compound material 30 may melt to form a deposit 31 that may be fusion bonded to the substrate 24. The deposition head 22 may provide an inert shield gas 32 around the deposition zone. The deposit 31 may be in the form of a line, which may have substantially the same width as the melt pool 25. The deposition head 22 may be manipulated using a computer numerical control (CNC) robot or gantry system to deposit one or more lines to form a first layer having a desired shape and dimensions. When the first layer has been completed, the deposition head 22 may be lifted by a pre-set Z-increment and the process may be repeated to form further layers on top of the first layer, until a desired three-dimensional build has been completed. The first several deposited layers may form a dilution zone (also known as a mixing zone), where there may be mixing between the parent material of the substrate 24 and the deposited compound material 30.

An example suitable DLD system may be a 0.5-axis TRUMPF DLD (blown powder) system fitted with a 4 KW disc laser DLD, an automatic spot change collimator (from 0.2 mm to 6 mm), and a SIEMENS powder feeder having a three-beam nozzle.

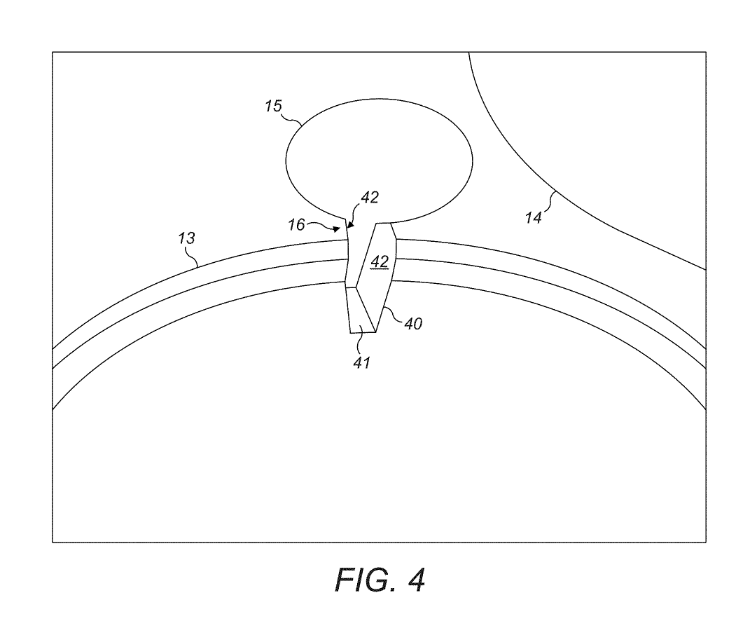

To repair a crack 20, material surrounding at least a portion of the crack 20 (to include the crack 20), more preferably surrounding the whole crack 20, may be removed to create a slot 40, as shown in FIG. 4. The slot 40 may have a generally V-shaped cross-sectional profile with a truncated bottom portion, such that the slot 40 may have a bottom surface 41 and side walls 42. The side walls 42 of the slot 40 may taper outwardly from the bottom surface 41 of the slot 40, which may improve bonding of the deposition material with the side walls 42. However, the tapering of the side walls 42 may be minimised to minimise the volume of material required to fill the slot 40. For example, the side walls 42 may be at an angle of from 8° to 14°, more preferably 10° to 12°, such as about 10.88° with respect to the normal to the bottom surface 41 of the slot 40. The depth of the slot 40 may be less than the depth of the cylinder head 10. The depth of the slot 40 may be less than or equal to 18 mm, more preferably less than or equal to 15 mm, such as about 13 mm. The maximum cross-sectional area of the slot 40 in the plane of the second face 12 of the cylinder head 10 may be less than or equal to 25 mm×13 mm, more preferably less than or equal to 32 mm×11 mm, more preferably less than or equal to 21 mm×9 mm. A preferred length of the slot 40 may be 8 mm at the second face 12 of the cylinder head 10 and 3 mm at the bottom surface 41 of the slot 40. The length of the slot 40 may vary in a linear manner. The width of the slot 40 may be determined by the width of the bridge 16 between the inlet port 13 and the injector port 15.

The slot 40 may be formed using any suitable machining process, such as milling or grinding. The process may be manual or automatic. For example, a machining tool used to form the slot 40 may be operated via CNC. A suitable CNC program may be created using ALPHACAM Mill software by Planit CAD/CAM Software, UK.

The slot 40 may then be filled using DLD. The term ‘fill’ is used herein to mean placing material into the slot 40 up to any level, including partially filling to a level less than the depth of the slot 40, filling to a level substantially equal to the depth of the slot 40, and overfilling to a level greater than the depth of the slot 40. Any suitable powdered metal may be used for the compound material 30, such as Colmonoy 25F or Colferology 139-P2 (supplied by Wallcolmonoy Ltd, UK). A suitable Z-increment for adjacent layers may be from 0.2 mm to 1 mm, preferably about 0.5 mm or about 0.8 mm. A suitable flow rate for the compound material 30 may be from 8 g/minute to 15 g/minute, more preferably 10 g/minute to 12.5 g/minute, such as about 10.5 g/minute or about 12.4 g/minute. Any suitable inert gas, such as Argon, may be used as the assistant gas. Alternatively, no assistant gas may be used and the deposition may be performed in air.

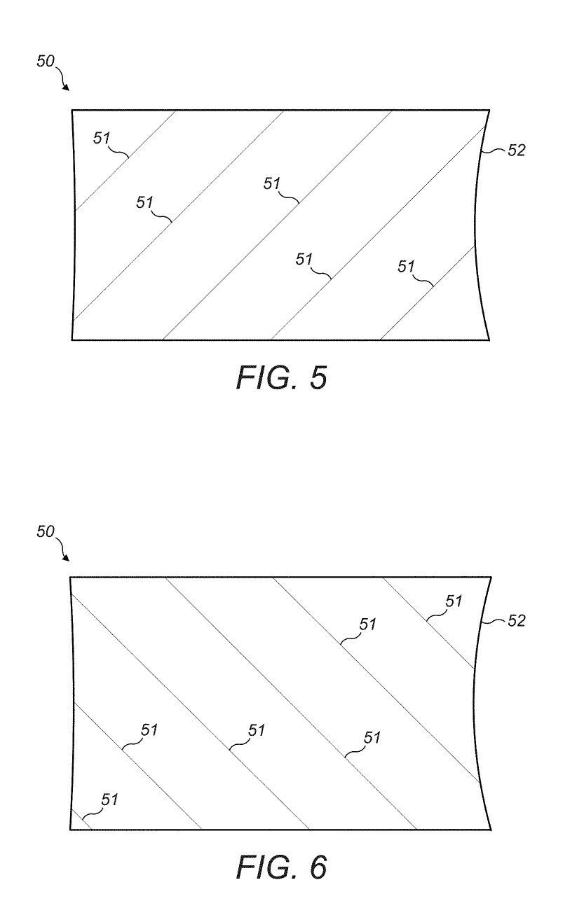

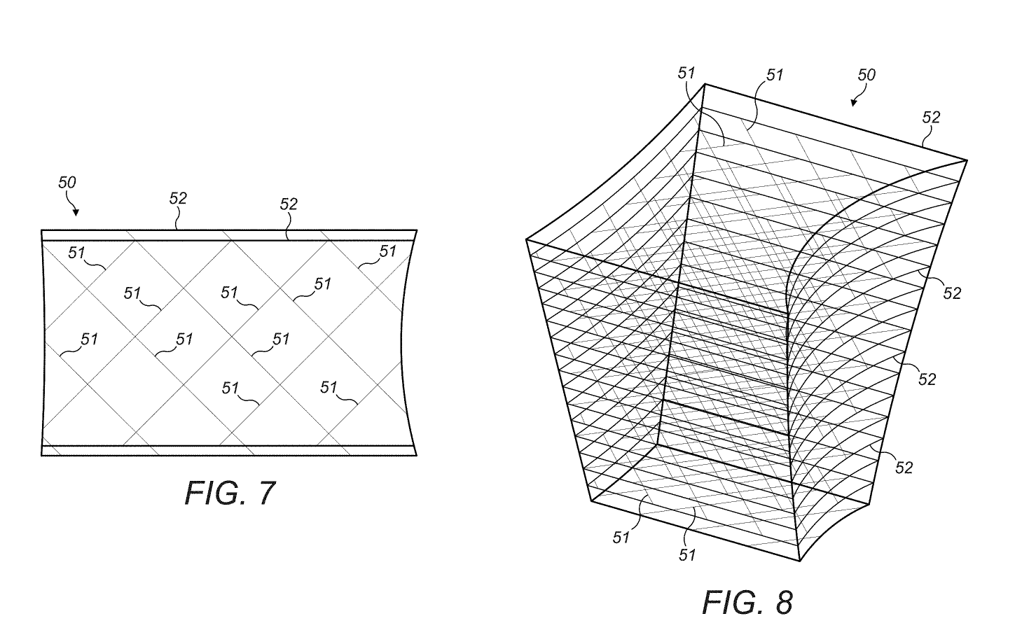

A suitable toolpath strategy for the DLD is shown in FIGS. 5 to 8. FIGS. 5 and 6 illustrate the toolpath strategy 50 for two adjacent layers, FIG. 7 shows a top plan view of the two adjacent layers together, and FIG. 8 shows a perspective view of the full toolpath strategy 50. The toolpath strategy 50 for each layer may comprise a raster scan 51 followed by a contour scan 52, with the raster scans 51 of adjacent layers being at an angle of other than 0° with respect to each other, more preferably at an angle of greater than 45° to each other, more preferably perpendicular to each other. The spacing between adjacent laser scanned tracks (i.e. the hatching distance) may be less than or equal to 1.5 mm, preferably 1.0 mm, and generally at least 0.1 mm, such that each layer may comprise several paths. A suitable focus number for the laser may be selected by depositing a sample test track of compound material 30 and ensuring that the width of the test track is greater than the spacing between adjacent laser scanned tracks (i.e. greater than the hatching distance).

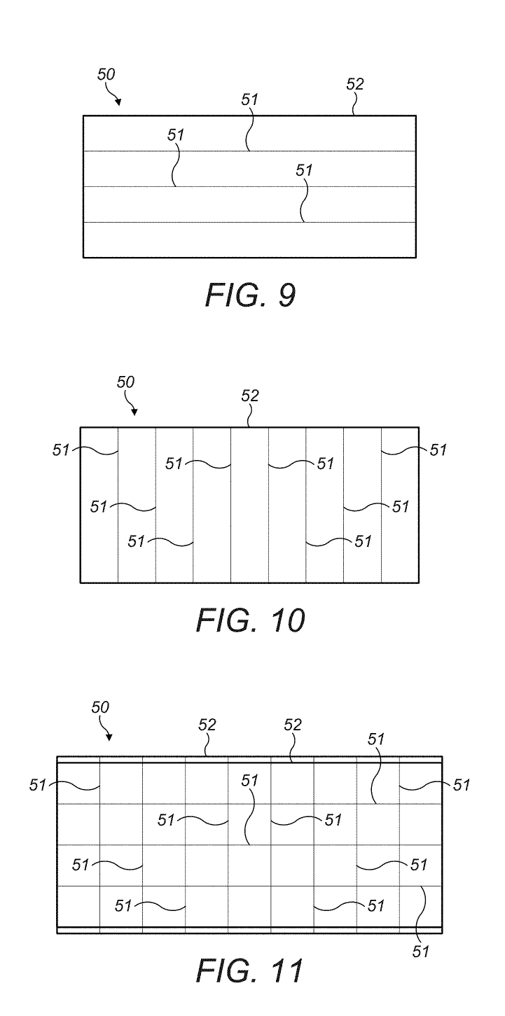

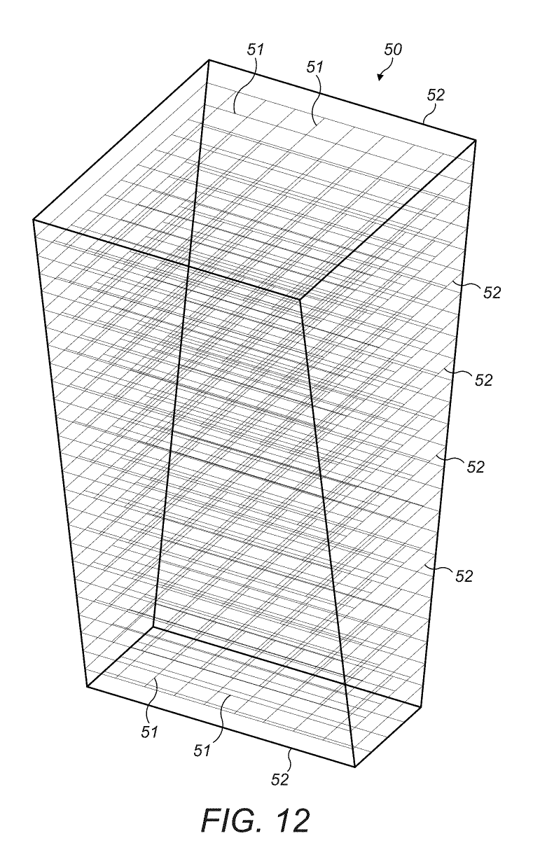

Alternatively, a simplified toolpath strategy may be used, having a straight profile at the inlet and injector ports 13,15 (rather than a curved profile). A suitable simplified toolpath strategy 50 is shown in FIGS. 9 to 12. Again, FIGS. 9 and 10 illustrate the toolpath strategy 50 for two adjacent layers, FIG. 11 shows a top plan view of the two adjacent layers together, and FIG. 12 shows a perspective view of the full toolpath strategy 50. Use of a simplified toolpath strategy 50 may facilitate consistent builds.

Prior to deposition, one or more pre-scans (also referred to herein as a pre-scanning operation) may be performed to preheat the bottom surface 41 of the slot 40. Pre-heating the bottom surface 41 of the slot 40 may burn off oil and/or other substances that may have penetrated the cylinder head 10 during its lifespan, and may thereby clean it. Use of a pre-scan may facilitate bonding between the bottom surface 41 of the slot 40 and the initial deposited layers. The one or more pre-scans may be performed on the bottom surface 41 of the slot 40 using the laser beam 23 but without feeding compound material 30. The one or more pre-scans may follow the same toolpath strategy as may be used for the first deposition layer. The one or more pre-scans may be performed at a first laser power and a first scan speed. The first laser power may be less than or equal to 700 W, more preferably less than or equal to 600 W, more preferably less than or equal to 500 W. For example, the first laser power may be selected from a range of from 100 W to 700 W, more preferably 200 W to 600 W, more preferably 300 W to 500 W, such as about 400 W. In some case, the first laser power may be less than or equal to 400 W, more preferably less than or equal to 300 W. For example, the first laser power may be selected from a range of from 200 W-300 W. The first scan speed may be less than or equal to 700 mm/minute, more preferably less than or equal to 600 mm/minute. In some cases, the first scan speed may be less than or equal to 500 mm/minute. For example, the first scan speed may be selected from a range of from 200 mm/minute to 600 mm/minute, more preferably 300 mm/minute to 500 mm/minute, such as about 400 mm/minute. Using more than one pre-scan may mean that the resulting heat in the bottom surface 41 of the slot 40 may dissipate less quickly, which may be advantageous. In one embodiment of the disclosure, three pre-scans may be performed.

After the one or more pre-scans, deposition may be performed at a second laser power and a second laser speed. The second laser power and second scan speed may be respectively equal to or different from the first laser power and first scan speed. The second laser power and second scan speed may be respectively greater than the first laser power and the first scan speed. The second first laser power may be less than or equal to 700 W, more preferably less than or equal to 600 W, more preferably less than or equal to 500 W. For example, the second laser power may be selected from a range of from 300 W to 700 W, more preferably 400 W to 600 W, more preferably 300 W to 500 W, such as about 500 W. The second scan speed may be less than or equal to 700 mm/minute, more preferably less than or equal to 600 mm/minute. The second scan speed may be selected from a range of from 200 mm/minute to 700 mm/minute, more preferably 300 mm/minute to 600 mm/minute, such as about 600 mm/minute.

In one embodiment of the disclosure, the second laser power and the second scan speed may be used for the initial deposited layers. The initial deposited layers may comprise the layers in the dilution zone. The initial deposited layers may comprise the first n layers, where n may be from one to five, preferably three. After these initial layers, a third laser power and a third scan speed may be used for the further layers. The third laser power and the third scan speed may be respectively greater than the second laser power and the second scan speed. For example, the third laser power may be selected from a range of from 700 W to 1100 W, more preferably 600 W to 1000 W. The third scan speed may be selected from a range of from 500 mm/minute to 1100 mm/minute, more preferably 400 mm/minute to 1000 mm/minute.

Using a relatively low laser power and scan speed for the one or more pre-scans and for the initial deposited layers may minimise porosity at the interface with the substrate by stabilising meltflow in the initial stages of the process. This may result in good bonding between the substrate and the deposited compound material. Using a higher laser power and a higher scan speed for further layers after the initial deposited layers, where porosity may be less problematic, may facilitate faster and more efficient deposition.

Impurities in the deposited layers may rise towards the surface of the build, i.e. into the upper layers of the build. Layers may therefore be deposited to a height greater than the depth of the slot 40, to form an overbuild. The overbuild (comprising the upper layers of the build), may subsequently be removed by machining, so that a surface of the build may become flush with the second face 12 of the cylinder head 10. This may help to minimise the impurities in the build.

Finishing steps, such as machining, may also be carried out on the surface of the walls of the build in the inlet port 13 and in the injector port 15, to provide a flush surface with the existing surface of those features. Such finishing steps may be particularly beneficial when a simplified toolpath geometry for deposition is used.

### INDUSTRIAL APPLICABILITY

The method of remanufacturing a cylinder head has industrial applicability in the field of internal combustion engines, and particularly in the field of diesel internal combustion engines.

A number of parametric studies were carried out to investigate the preferred parameters for direct laser deposition.

### Study 1

A parametric study was performed under the processing conditions shown in Table 1. The samples were fabricated in air using Colmonoy 25F, with a pre-scan and a focus number of 2.

TABLE 1

| | | | Average | | Powder | | Actual | Build height |
|---|---|---|---|---|---|---|---|---|
| | | Z- | laser | Scan | flow | Specified | build | accuracy |
| Sample | Pre- | increment | power | speed | rate | height | height | (excess/ |
| number | scan | (mm) | (W) | (mm/min) | (g/min) | (mm) | (mm) | under/good) |
| 1 | Yes | 0.5 | 800 | 1000 | 12.4 | 15 | 14 | Good |
| 2 | Yes | 0.5 | 1000 | 1000 | 12.4 | 15 | 20 | Excess |
| 3 | Yes | 0.5 | 1000 | 1000 | 8.6 | 15 | 12 | Under |
| 4 | Yes | 0.5 | 1000 | 1000 | 10.5 | 15 | 14-15 | Good |
| 5 | Yes | 0.8 | 1000 | 1000 | 12.4 | 15 | 10-11 | Under |
| 6 | Yes | 0.8 | 1000 | 1400 | 12.4 | 15 | 5 | Under |
| 7 | Yes | 0.8 | 1000 | 800 | 12.4 | 15 | 15-16 | Good |
| 8 | No | 0.5 | 800 | 1000 | 12.4 | 15 | 15-16 | Good |
| 9 | No | 0.8 | 1000 | 800 | 12.4 | 15 | 15 | Good |
| 10 | No | 0.5 | 800 | 1000 | 12.4 | 15 | 14 | Good |

It can be seen from samples 1 and 2 that with a small Z-increment and a fixed laser scanning speed and powder flow rate, the build height may increase with increased laser power. The higher laser power may help to capture and melt more incoming powder particles, which may add to the build height. As shown by samples 2 to 4, with other conditions being fixed, increased powder flow rate may also lead to increased build height. Samples 5 to 7 indicate that increased laser scanning speed may lead to continued decrease in build height. Thus the processing condition may affect the build height by affecting the powder capture and melting rate on each layer.

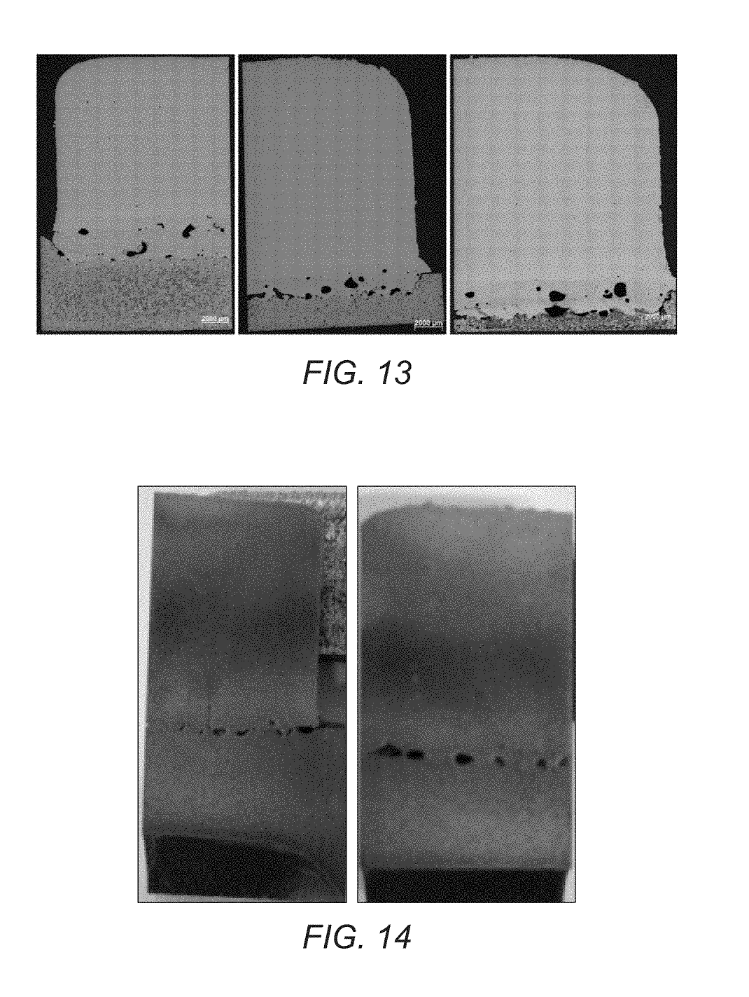

FIG. 13 shows a cross section of samples 1, 4, and 7 (from left to right). All three samples showed a porosity level lower than 0.5% in area fraction. However, at the interface between the deposits and substrates, a number of large pores 60 had developed. These pores 60 may be associated with gas formation during high laser power pre-scanning of the substrate. The cast iron substrates may contain a high carbon level, and when they were melted at high powers a lot of gas may have been released due to the reaction between oxygen in the air and carbon in the substrates. This may have destabilised the melt flow during pre-scanning and even during the first several layers' deposition.

To avoid such violent gas formation and to mitigate porosity formation at the interface, a pre-scan was omitted for samples 8 to 10. FIG. 14 shows a cross section of samples 8 and 9 (from left to right). It can be seen that the bonding at the interface is still poor.

Low laser power pre-scanning was performed using pre-scan conditions shown in Table 2, and deposition conditions as per sample 1.

TABLE 2

| Sample | Average pre-scan | Pre-scan |
|---|---|---|
| number | laser power (W) | speed (mm/min) |
| 11 | 200 | 1000 |
| 12 | 300 | 1000 |
| 13 | 400 | 1000 |

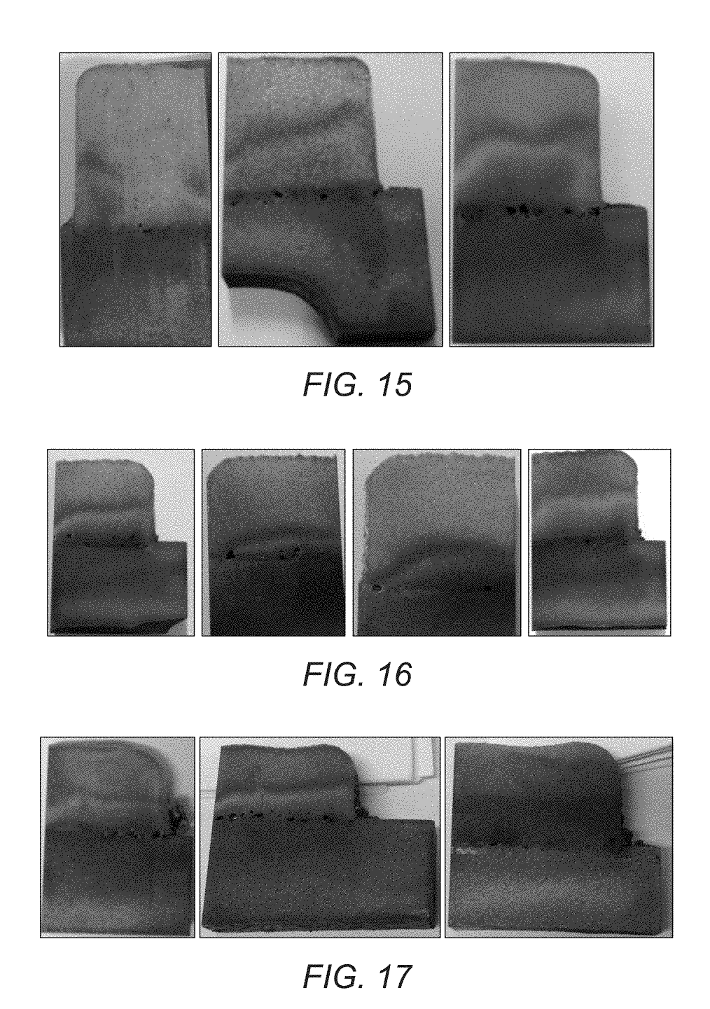

The results for samples 11 to 13 are shown in FIG. 15 (from left to right). It can be seen that with a low laser power pre-scan the bonding at the interface may be improved to some extent.

### Study 2

A parametric study was performed to investigate the influence of spot size (defined by focus number) on the width of the laser scanned tracks. Porosity development at the interface between the substrate and the deposited material was also investigated. It was found that the width of the laser scanned tracks may generally increase with increased focus number, with a focus number of 2 giving very limited overlapping between neighbouring tracks and a focus number of 10 giving a reasonable overlap (around 0.5 mm). A focus number of 15 may lead to even more overlap between neighbouring tracks but also may also result in excess build height in the subsequent layers. However, even with increased overlap between tracks, the pores 60 in the first layer or at the interfacial regions were not fully removed or significantly reduced (see FIG. 16 which shows, from left to right, focus numbers of 8, 10, 12, and 15 respectively). The pores 60 tend to be present within the scanned tracks, suggesting their formation may be due to melt splashing or unstable melt flow behaviour.

### Study 3

A parametric study was performed to investigate deposition using argon as a shield gas. Low laser power pre-scanning was performed using pre-scan conditions shown in Table 3, and deposition conditions as per sample 1.

TABLE 3

| Sample | Average pre-scan | Pre-scan |
|---|---|---|
| number | laser power (W) | speed (mm/min) |
| 14 | 200 | 1000 |
| 15 | 300 | 1000 |
| 16 | 400 | 1000 |

The results for samples 14 to 16 are shown in FIG. 17 (from left to right). Sample 16 was found to show minimum porosity at the interface. After polishing, this sample was shown to still contain several large pores 60 and some cracks at the interface.

### Study 4

A parametric study was performed on the first layer deposition. The results are shown in Table 4.

TABLE 4

| | | | Depo- | | | |
|---|---|---|---|---|---|---|
| | Pre-scan | | sition | Depo- | | Powder |
| | laser | Pre-scan | laser | sition | | flow |
| Sample | power | speed | power | speed | Focus | rate |
| number | (W) | (mm/min) | (W) | (mm/min) | number | (g/min) |
| 17 | 200 | 500 | 600 | 500 | 10 | 10.5 |
| 18 | 200 | 1000 | 800 | 1000 | 10 | 12.4 |
| 19 | 200 | 500 | 600 | 500 | 15 | 10.5 |
| 20 | 200 | 600 | 800 | 600 | 10 | 12.4 |
| 21 | 200 | 1000 | 800 | 1000 | 10 | 12.4 |
| 22 | 200 | 600 | 800 | 600 | 10 | 12.4 |
| 23 | 200 | 500 | 600 | 500 | 10 | 10.5 |
| 24 | 200 | 300 | 600 | 300 | 10 | 10.5 |

Samples 1, 6, 7, and 8, which generally had relatively low laser power and scanning speeds for both pre-scan and deposition, tended to show no porosity in the first layer. These conditions are thus considered advantageous for the bonding at the substrate/build interface.

### Study 5

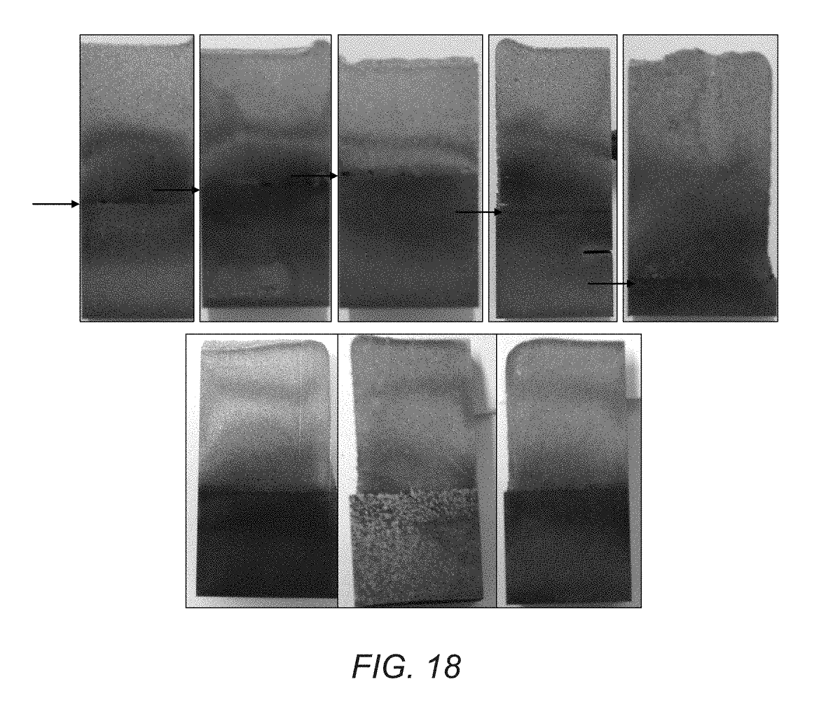

Based on the implications of the first layer deposition parametric study, several processing conditions (shown in Table 5) were investigated to fabricate whole samples. The results for samples 25 to 32 are shown in FIG. 18 (from left to right). It can be seen that using low laser power and scanning speed for pre-scan and the several initial DLD layers (to stabilise the melt flow at the beginning), the porosity at the interface may be greatly reduced, particularly for Samples 28 to 32. As long as the first several layers are built with low laser power and scan speed, the laser power and scan speed after first several layers may not affect the porosity development in the interfacial region. As such, a higher laser power and scan speed may be used to build samples after first several DLD layers.

TABLE 5

| | Pre-scan | | | First three layers' deposition | | | | Remaining layers' deposition | | | |
|---|---|---|---|---|---|---|---|---|---|---|---|
| | Laser | Scan | | Laser | Scan | | Flow | Laser | Scan | | Flow |
| Sample | power | speed | Focus | power | speed | Focus | rate | power | speed | Focus | rate |
| number | (W) | (mm/min) | number | (W) | (mm/min) | number | (g/min) | (W) | (mm/min) | number | (g/min) |
| 25 | 200 | 500 | 10 | 600 | 500 | 10 | 10.5 | 600 | 500 | 10 | 10.5 |
| 26 | 400 | 400 | 10 | 600 | 400 | 10 | 10.5 | 600 | 400 | 10 | 10.5 |
| 27 | 600 | 400 | 10 | 600 | 400 | 10 | 10.5 | 600 | 400 | 10 | 10.5 |
| 28 | 400 | 400 | 10 | 600 | 400 | 10 | 10.5 | 800 | 800 | 10 | 12.4 |
| 29 | 400 | 400 | 10 | 400 | 400 | 10 | 10.5 | 600 | 600 | 10 | 12.4 |
| 30 | 400 | 400 | 10 | 600 | 300 | 10 | 12.4 | 600 | 600 | 10 | 12.4 |
| 31 | 400 | 400 | 10 | 600 | 400 | 10 | 12.4 | 1000 | 1000 | 10 | 12.4 |
| 32 | 400 | 400 | 10 | 600 | 400 | 10 | 12.4 | 1000 | 1000 | 10 | 12.4 |

1. A method of remanufacturing a cylinder head, the method comprising the steps of:
removing material from the cylinder head around at least a portion of a crack in the cylinder head to form a slot; and
applying a compound material using direct laser deposition to fill the slot; wherein
the direct laser deposition includes:
performing a pre-scanning operation at a first laser power and a first scan speed; and
depositing the compound material at a second laser power and a second scan speed, wherein the second laser power and the second scan speed being equal to or different from the first laser power and first scan speed; and wherein
the first laser power and the second laser power are less than or equal to 700 W; and
the first scan speed and second scan speed are less than or equal to 700 mm/minute.

2. A method according to claim 1, wherein the first laser power and the second laser power are selected from a range of from 300 W to 500 W.

3. A method according to claim 1, wherein the first scan speed and second scan speed are selected from a range of from 300 mm/minute to 600 mm/minute.

4. A method according to claim 1, wherein the second laser power and the second scan speed are respectively greater than the first laser power and the first scan speed.

5. A method according to claim 1, wherein the first laser power is less than 400 W.

6. A method according to claim 5, wherein the first laser power is selected from a range of from 200 W to 300 W.

7. A method according to claim 1, wherein the direct laser deposition comprises a plurality of pre-scanning operations.

8. A method according to claim 1, comprising:
forming a plurality of initial layers of deposited compound material at the second laser power and the second scan speed; and
forming a plurality of subsequent layers of deposited compound material at a third laser power and a third scan speed, wherein the third laser power and the third scan speed are respectively greater that the second laser power and the second scan speed.

9. A method according to claim 8, wherein the initial layers comprise the layers in a dilution zone where mixing occurs between deposited material and material of the cylinder head.

10. A method according to claim 9, wherein the initial layers comprise the first n layers, where n is in the range of 1 to 5.

11. A method according to claim 10, wherein n is equal to 3.

12. A method according to claim 1, wherein the slot comprises a bottom surface.

13. A method according to claim 12, wherein the slot comprises side walls that taper outwardly from the bottom surface of the slot.

14. A method according to claim 13, wherein the side walls are at an angle of substantially 8° to 14° with respect to the normal to the bottom surface of the slot.

15. A method according to claim 1, wherein a maximum cross-sectional area of the slot is less than or equal to 25 mm×13 mm.

16. A method according to claim 1, wherein a depth of the slot is less than or equal to 18 mm.

17. A method according to claim 1, wherein a simplified toolpath strategy is used for the direct laser deposition.

18. A method according to claim 1, wherein the compound material is Colmonoy 25F.

19. A method according to claim 16, comprising applying the compound material to fill the slot to a height greater than the depth of the slot, to form an overbuild.

20. A method according to claim 19, comprising machining the cylinder head to remove the overbuild so that a surface of the deposited compound material is flush with a face of the cylinder head.
